(19) United States
(12) Patent Application Publication
(10) Pub. No.: US 2013/0262741 A1
(43) Pub. Date: Oct. 3, 2013

(54) SYSTEM AND METHOD FOR SUPPORTING MULTIPLE AUTHENTICATION SYSTEMS

(71) Applicants: Robert Marten Bultman, Louisville, KY (US); Jeff Donald Drake, Louisville, KY (US)

(72) Inventors: Robert Marten Bultman, Louisville, KY (US); Jeff Donald Drake, Louisville, KY (US)

(21) Appl. No.: 13/431,293

(22) Filed: Mar. 27, 2012

(51) Int. Cl. G06F 12/00

(52) U.S. Cl. 711/103; 711/E12.008

(57) ABSTRACT

A system for supporting multiple authentication systems. The system includes a computing device, a host memory for storing a plurality of software stacks, a flash memory configured to be programmed with one of the plurality of software stacks, and at least one processor. The at least one processor is programmed to identify a model of the device, select a software stack from the plurality of software stacks based on a device model of the computing device, and program the selected software stack into the flash memory. The device may be an electrical appliance.

### BACKGROUND OF THE INVENTION

The field of the invention relates generally to software stacks, and more specifically to a system and method for supporting multiple authentication systems.

Current electrical devices can provide a number of services, including telephony services, short messaging service (SMS), media-player services, image/video services and e-mail communication. Both the software and the hardware of such devices include specific configurations. For example, configuration of software in a conventional device requires separate software builds for each device. Conventionally, the specific software bundles are loaded at the time the device is manufactured. Accordingly, device configuration at the manufacturing stage typically requires at least one factory line for each type of device.

### BRIEF SUMMARY OF THE INVENTION

In one aspect, a system for supporting multiple authentication systems is provided. The system includes a computing device (hereinafter “device” or “device 102”), a host memory for storing a plurality of software stacks, a flash memory configured to be programmed with one of the plurality of software stacks, and at least one processor. The at least one processor is programmed to identify a model of the device, select a software stack from the plurality of software stacks based on a model of the device, and program the selected software stack into the flash memory. In one embodiment, the device may be an electrical appliance. Non-limiting examples of devices and/or electrical appliances include: a refrigerator, a washer, a dryer, an oven, a stove, a microwave oven, a dishwasher, and a heating, ventilation, and an air conditioning system.

In another aspect, a method is provided. The method includes identifying a model of a device, selecting a software stack from a plurality of software stacks based on the model of the device, the plurality of software stacks being stored in a host memory of the device, and programming the selected software stack into a flash memory of the device.

In yet another aspect, an electrical appliance is provided. The electrical appliance includes a host memory for storing a plurality of software stacks, a flash memory configured to be programmed with one of the plurality of software stacks, and at least one processor. The at least one processor is programmed to identify a model of the electrical appliance, select a software stack from the plurality of software stacks based on a model of the electrical appliance, and program the selected software stack into the flash memory.

### BRIEF DESCRIPTION OF THE DRAWINGS

The present disclosure is described in detail below with reference to the attached figures.

FIG. 1 is block diagram of a system for providing multiple software stacks.

FIG. 2 is a process flow diagram of a method for providing a software stack for multiple authentication systems.

### DETAILED DESCRIPTION OF THE INVENTION

While embodiments of the disclosure are illustrated and described herein with reference to software stacks, and more specifically to a system and method for supporting multiple authentication systems, aspects of the disclosure are operable with any system that performs the functionality illustrated and described herein, or its equivalent. Further, aspects of the present disclosure enable storing different versions of a software stack, each dedicated to a single authentication system. Thus, while conventional device configurations are required to be determined at the manufacturing stage and typically require at least one factory line for each model of device, aspects of the present disclosure enable a plurality of different versions of a software stack to be stored and thus multiple factory lines are not necessary. The device (i.e., a computing device) just described may be an electrical appliance.

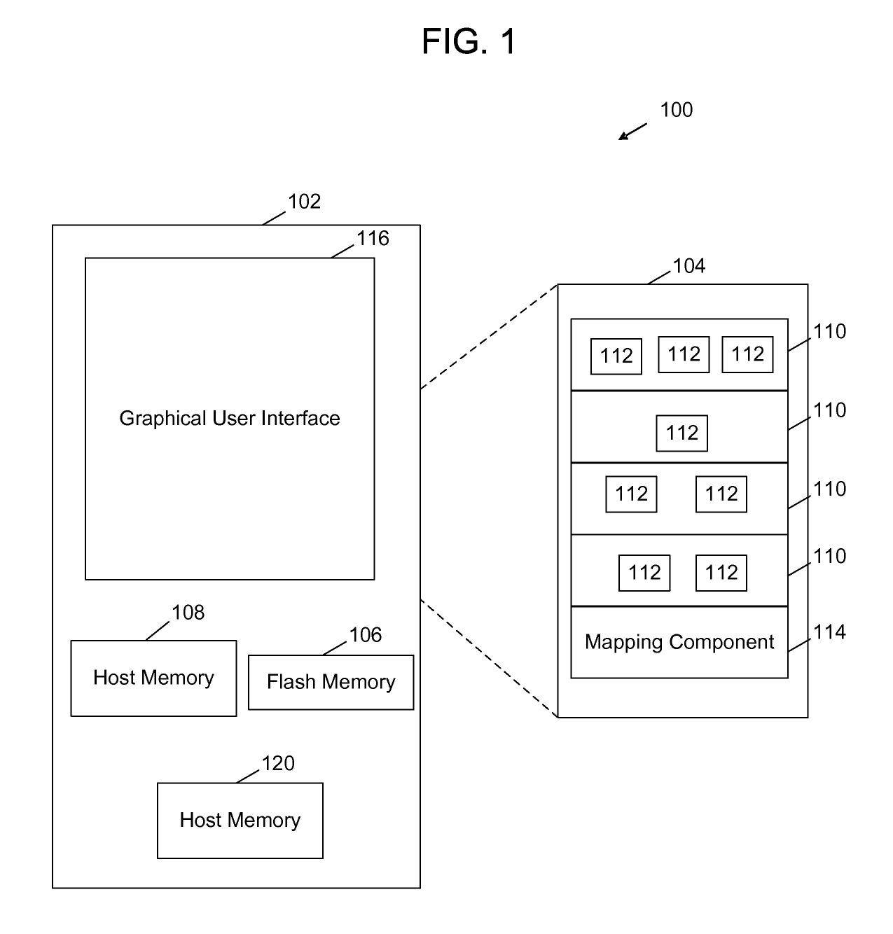

FIG. 1 illustrates a block diagram of an example system 100 that can be used to configure a software stack (e.g., a set of programs that work together to produce a result, such as an operating system and its applications). System 100 includes a device 102 (e.g., a computing device/electrical appliance) and software stacks 104. System 100 further includes a flash memory 106 and a host memory 108. While illustrated as a device 102, system 100 can include other devices without departing from the scope of the disclosure (e.g., a desktop computer).

Software stacks 104 include a set of applications 110 where each is assigned or otherwise associated with one or more models of device 102. In general, software stacks 104 are stored/located in host memory 108 and programmed into flash memory 106 when needed. Applications 110 include any suitable application software configured to run on at least one model/type of device 102. For example, an application 110 may include a device driver configured to enable higher-level software programs to interact with one or more hardware components. In some implementations, one or more of the set of applications 110 may be software programs that process information captured, received or otherwise identified by a hardware component. The set of applications 110 may include software programs associated with one or more of the following: an operating system, wireless communication, GUI 116, sensors, images, electronic messaging, web browsing, media processing, GPS/Navigation, camera, and/or other hardware components and/or software programs. The set of applications 110 may be based on any appropriate computer language such as, for example, C, C++, Java, Perl, Visual Basic, 4GL, and/or others.

Aspects of the present disclosure enable storing different versions of a software stack, each dedicated to a single authentication system (e.g., each software stack is dedicated to one system that supports a user-name and password). For example, when a system is installed, a software stack associated with the authentication system used is selected and installed. Installation can be via many methods including a loading of shared libraries, scripts, or programming of a program or library in a flash memory. In one embodiment, host memory 108 contains a large non-volatile storage while flash memory 106 is of smaller size and is also where the software stack or program associated with only one authentication mechanism resides.

In one embodiment, host memory 108 has the capability of programming flash memory 106. In one embodiment, the many flash memory programs associated with each authentication mechanism are stored within host memory 108. At run time, a configuration mechanism is used such that a communications micro software stack associated with a desired authentication mechanism is selected from the many software stacks (e.g., software stacks 104) located in host memory 108 and programmed into flash memory 106.

In one embodiment, system 100 may automatically configure a subset of applications in a software stack and associated properties of the applications based, at least in part, on a model or type of device 102. In this example, device 102 executes multiple software stacks. In general, a software stack includes a plurality of applications 110 that may be executed on one or more devices 102 to produce a desired result. In one embodiment, the software stacks pre-exist on the devices 102 and are initiated when the model or type of the device 102 is discovered. For example, the plurality of applications 110 may include one or more of the following: a phone application, a user interface application, a camera application, Global Positioning System (GPS) application, a media application, wireless communication applications, and/or others. In some implementations, system 100 may automatically configure, set, or otherwise identify those applications in the software stack allowed, authorized, or otherwise executable on one of a plurality of different models or types of devices (“hereinafter “model(s) of device(s)”.

In addition, system 100 may automatically configure properties of specified applications in accordance with a model of device 102. For example, system 100 may configure a media application to process both multimedia and image files for one model device (e.g., a video) while configuring a media application to process only image files for a second model of device 102. By dynamically determining a software stack for different models at a time other than build, system 100 can, in some implementations, provide a software stack to any of a plurality of different models of a device and automatically configure the specified applications and associated properties based, at least in part, on the model of device 102.

In one embodiment, device 102 includes a Graphical User Interface (GUI) 116. Software stacks 104 each include applications 110 having a plurality of properties 112, and a mapping processor component 114. In one embodiment, mapping component 114, when executed by processor 120, identifies a model/type of device 102 in response to a particular event (e.g., initialization, activation). Based, at least in part, on the identified model/type, mapping component 114 may automatically map the model of device 102 to one or more of applications 110. In addition, mapping component 114, when executed by processor 120, may automatically map device 102 to one or more properties 112 of the identified applications 110. In connection with identifying applications 110 and associated properties 112 for device 102, mapping component 114 may automatically configure (or publish information to allow a respective application to self-configure) the identified applications 110 and associated properties 112 for execution on device 102 independent of configuring those applications not mapped to the model of device 102.

Device 102 can include any software, hardware, and/or firmware configured to execute one or more applications 110. In one embodiment, device 102 can be, for example, a refrigerator, a washer, a dryer, an oven, a stove, a microwave oven, a dishwasher, and a heating, ventilation, an air conditioning system, a handheld computer, a personal digital assistant (PDA), a cellular telephone, a network appliance, a camera, a smart phone, an enhanced general packet radio service (EGPRS) mobile phone, a network base station, a media player, a navigation device, an email device, a game console, or a combination of any two or more of these data processing devices and/or other data processing devices.

GUI 116 includes a graphical user interface operable to enable a user of device 102 to interface with at least a portion of system 100 for any suitable purpose, such as using applications 110. Generally, GUI 116 provides a particular user with an efficient and user-friendly presentation of data provided by or communicated within system 100. The term graphical user interface may be used in the singular or in the plural to describe one or more graphical user interfaces and each of the displays of a particular graphical user interface. GUI 116 can include any graphical user interface, such as a generic web browser or touch screen, which processes information in system 100 and presents the results to the user.

In addition, applications 110 may include properties 112. In one embodiment, properties 112 may be configured based, at least in part, on the model/type of device 102. For example, two different models of device 102 may include the same application 110 but have different properties 112 and/or different configurations of properties 112. In some implementations, properties 112 and/or the configuration of properties 112 may be based, at least in part, on a version of a hardware component on device 102. As mentioned above, the hardware components may include different versions for the different models of device 102. In this implementation, different properties 112 and/or different configurations of the properties 112 may be associated with the different models. For example, a display may be a non-interactive display for one model and a touch-screen display for a different model. In this example, an application 110 may include a property 112 configured to process touches detected by the first model.

Now described is an example of how mapping the authentication system can occur once the model or type of the device 102 is determined This mapping can occur automatically upon initialization of the system. In one embodiment, mapping component 114 is software configured to identify applications 110 associated with a model. For example, mapping component 114 may automatically identify a model of device 102 in response to an event (e.g., initialization) and automatically configure applications 110 associated with a model for execution on the device 102, and identify an applicable software stack 104 located in host memory 108.

Alternatively, mapping component 114 may merely publish configuration settings and information about the model of the device 102. These configuration setting and/or model information can be used by respective applications to configure correctly for a given device. In regards to identifying the model of device 102, mapping component 114 may determine the model of device 102 from information independent of software stacks 104. For example, the mapping component 114 may determine or otherwise identify the model of device from any software, hardware, and/or firmware in device 102. In some implementations, mapping component 114 can determine the model of device from locally stored software elements executed by device 102. In response to at least identifying the model of device 102, mapping component 114 may determine applications 110 associated with device 102. For example, mapping component 114 may map the model of device 102 to one or more applications 110.

Turning to configuring the identified applications 110, mapping component 114 can, in some implementations, automatically configure applications 110 and associated properties 112 in accordance with the model of device 102. In some implementations, configuration instructions may be identified and be based on one or more of the following: the version of hardware components included in device 102; a level of service purchased by the user of device 102; and/or others.

In one aspect of operation, mapping component 114 may automatically determine a model of device in response to, for example, initialization of device 102. In connection with identifying the model of device 102, the mapping component 114 may map the model of device 102 to one or more applications 110 in software stacks 104 located in host memory 108. In addition, mapping component 114 may map the model of device 102 to one or more properties 112 and/or configuration of properties 112. In accordance with the mapping information, mapping component 114 may configure the one or more identified applications mapping component 114 for execution by device 102.

Turning to a description of operation of software stacks 104 of FIG. 1, software stacks 104 are loaded in device 102, and more specifically, software stacks 104 are stored in host memory 108. In response to at least an event (e.g., initialization, activation), mapping component 114 automatically identifies the device model/type. For example, a model of device 102 may be a string of characters locally stored in device 102. Mapping component 114 may automatically identify one or more applications 110 associated with the model of device 102. For example, mapping component 114 executed by device 102 may identify an application 110 configured to manage wireless components for wireless communications. Thus, once an applicable software stack is identified, the software stack is programmed into flash memory 106. In one embodiment, the software stack will hold appropriate information for the authentication system. Thus selecting a particular software stack is, in effect, choosing what authentication system to use and what parameters the determined model of device 102 will use.

In addition, mapping component 114 may identify instructions for setting one or more properties 112 for each of the identified applications 110. For example, mapping component 114 for device 102 may identify an application 110 for processing and/or managing locally stored appliance default settings. In connection with identifying applications 110 and associated properties 112, mapping component 114 automatically configures applications 110 and associated properties 112 for execution by device 102. As mentioned above, software stacks 104 can, in some embodiments, enable the development of a software stack that can be loaded in a plurality of different devices and automatically configure one or more of the applications 110 to execute on the different devices.

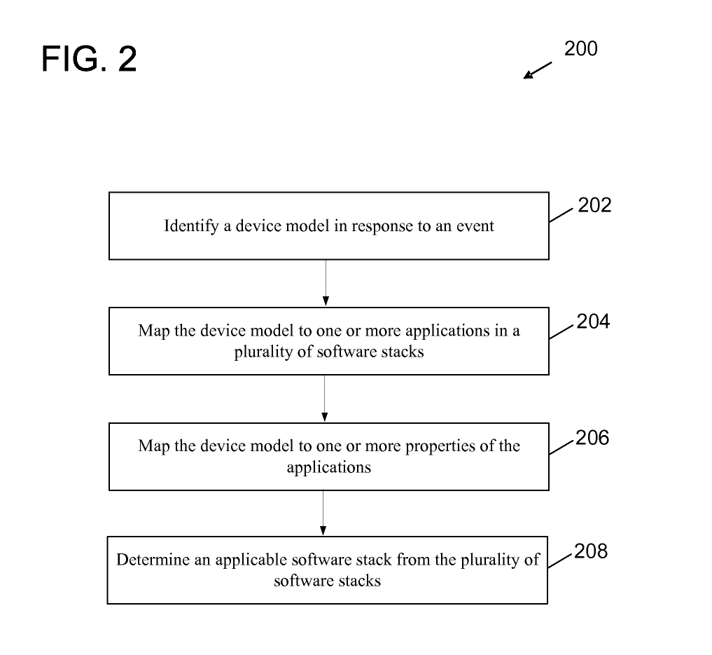

FIG. 2 is a flow chart illustrating an example method 200 for automatically configuring a software stack in accordance with some implementations of the present disclosure. Generally, method 200 describes an example technique where a single software stack is selected from a plurality of software stacks located in host memory 108, and the selected software stack is programmed into flash memory 106. System 100 contemplates using any appropriate combination and arrangement of logical elements implementing some or all of the described functionality.

Method 200 begins at 202 where a mapping component automatically identifies a model of device 102 in response to an event. For example, the mapping component 114 as shown in FIG. 1 may automatically identify a model of device 102 in response to at least initialization of the device. For example, mapping component 202 recognizes a model number, software pertaining to a particular model, and the like. At 204, the model of device 102 is mapped to one or more applications in software stacks 104. In the example, mapping component 114 may map the model of device 102 to a subset of the applications 110 that is less than all of the applications 110. Next, at 206, mapping component 114 maps the model of device 102 to one or more properties of applications 110. As for the example, mapping component 114 may map the model of device 102 to one or more properties 112 of the identified applications 110, which may include identifying instructions for configuring the one or more properties 112. In accordance with the model of device 102, the identified applications and properties are automatically configured and mapping component 114 determines an applicable software stack from software stacks 104 located in host memory 108 for execution in device 102 at 208. Returning to the example, mapping component 114 may automatically configure the identified applications 110 and properties 112 for executing by device 102 in accordance with the model of device 102 and the applicable software stack programmed into flash memory 106.

### Exemplary Operating Environment

A controller or computing device such as described herein has one or more processors or processing units, system memory, and some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal, such as a carrier wave or other transport mechanism, and include any information delivery media. Combinations of any of the above are also included within the scope of computer readable media.

The controller/computer may operate in a networked environment using logical connections to one or more remote computers, such as a remote computer. Although described in connection with an exemplary computing system environment, embodiments of the present disclosure are operational with numerous other general purpose or special purpose computing system environments or configurations. The computing system environment is not intended to suggest any limitation as to the scope of use or functionality of any aspect of the present disclosure. Moreover, the computing system environment should not be interpreted as having any dependency or requirement relating to any one or combination of components illustrated in the exemplary operating environment.

Embodiments of the present disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the present disclosure may be implemented with any number and organization of such components or modules. For example, aspects of the present disclosure are not limited to the specific computer-executable instructions or the specific components or modules illustrated in the figures and described herein. Other embodiments of the present disclosure may include different computer-executable instructions or components having more or less functionality than illustrated and described herein. Aspects of the present disclosure may also be practiced in distributed computing environments where tasks are performed by remote processing devices that are linked through a communications network. In a distributed computing environment, program modules may be located in both local and remote computer storage media including memory storage devices.

Aspects of the present disclosure transform a general-purpose computer into a special-purpose computing device when configured to execute the instructions described herein.

The order of execution or performance of the operations in embodiments of the present disclosure illustrated and described herein is not essential, unless otherwise specified. That is, the operations may be performed in any order, unless otherwise specified, and embodiments of the present disclosure may include additional or fewer operations than those disclosed herein. For example, it is contemplated that executing or performing a particular operation before, contemporaneously with, or after another operation is within the scope of aspects of the present disclosure.

When introducing elements of aspects of the present disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the present disclosure in detail, it will be apparent that modifications and variations are possible without departing from the scope of aspects of the present disclosure as defined in the appended claims. As various changes could be made in the above constructions, products, and methods without departing from the scope of aspects of the present disclosure, it is intended that all matter contained in the above description and shown in the accompanying drawings shall be interpreted as illustrative and not in a limiting sense.

This written description uses examples to disclose the claimed subject matter, including the best mode, and also to enable any person skilled in the art to practice the claimed subject matter, including making and using any devices or systems and performing any incorporated methods. The patentable scope of the present disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for supporting multiple authentication systems, the system comprising:
a computing device;
a host memory for storing a plurality of software stacks;
a flash memory configured to be programmed with one of the plurality of software stacks; and
at least one processor programmed to:
identify a model of the device;
select a software stack from the plurality of software stacks based on a model of the device; and
program the selected software stack into the flash memory.

2. The system of claim 1, wherein the processor is further programmed to determine a model of the device in response to at least one event.

3. The system of claim 2, wherein the event is at least one of initialization or activation of the device.

4. The system of claim 1, wherein the device is one of a refrigerator, a washer, a dryer, an oven, a stove, a microwave oven, a dishwasher, and a heating, ventilation, and an air conditioning system.

5. The system of claim 1, wherein the at least one processor is further programmed to select a software stack based on one or more applications in the software stack.

6. The system of claim 5, wherein the at least one processor is further programmed to select a software stack based on one or more properties of an application in the software stack.

7. A method, comprising:
identifying, using a processor, a model of a device;
accessing and selecting a software stack from a plurality of software stacks based on the identified model of the device, the plurality of software stacks being stored in a host memory of the computing device; and
programming the selected software stack into a flash memory of the device.

8. The method of claim 7, further comprising:
determining, using the processor, the model of the device in response to at least one event.

9. The method of claim 8, wherein the event is at least one of initialization or activation of the device.

10. The method of claim 7, wherein the device is one of a refrigerator, a washer, a dryer, an oven, a stove, a microwave oven, a dishwasher, and a heating, ventilation, and air conditioning system.

11. The method of claim 7, wherein selecting a software stack from the plurality of software stacks based on a model of the device further comprises:
selecting a software stack based on one or more applications in the software stack

12. The method of claim 11, wherein selecting a software stack from the plurality of software stacks based on a model of the device further comprises:
selecting a software stack based on one or more properties of an application in the software stack

13. An electrical appliance, comprising:
a host memory for storing a plurality of software stacks;
a flash memory configured to be programmed with one of the plurality of software stacks; and
at least one processor programmed to:
identify a model of the electrical appliance;
select a software stack from the plurality of software stacks based on a a model of the electrical appliance; and
program the selected software stack into the flash memory.

14. The electrical appliance of claim 13, wherein the processor is further programmed to determine a model of the electrical appliance in response to at least one event.

15. The electrical appliance of claim 14, wherein the event is at least one of initialization or activation of the electrical appliance.

16. The electrical appliance of claim 13, wherein the electrical appliance is one of a refrigerator, a washer, a dryer, an oven, a stove, a microwave oven, a dishwasher, and a heating, ventilation, and an air conditioning system.

17. The electrical appliance of claim 13, wherein the at least one processor is further programmed to select a software stack based on one or more applications in the software stack.

18. The electrical appliance of claim 17, wherein the at least one processor is further programmed to select a software stack based on one or more properties of an application in a software stack.

19. The electrical appliance of claim 14, wherein each software stack is dedicated to a single authentication system.
